(19) United States
(12) Patent Application Publication
(10) Pub. No.: US 2014/0247697 A1
(43) Pub. Date: Sep. 4, 2014

(54) SEISMIC SOURCE CALIBRATION TECHNIQUE AND SYSTEM

(71) Applicant: WESTERNGECO L.L.C., Houston, TX (US)

(72) Inventor: CLAUDIO BAGAINI, BEKKESTUA (NO)

(73) Assignee: WESTERNGECO L.L.C., HOUSTON, TX (US)

(21) Appl. No.: 13/783,146

(22) Filed: Mar. 1, 2013

(51) Int. Cl. G01V 1/38

(52) U.S. Cl. CPC G01V 1/3861
USPC 367/142

(57) ABSTRACT

A technique includes determining at least one parameter to regulate actuation of a seismic source based on a frequency-based maximum deliverable output for the source. The technique includes using at least one sensor to acquire a measurement of an output of the source in response to the source being regulated using the at least one parameter and processing data representative of the measurement in a processor-based machine to selectively update the frequency-based maximum deliverable output and the at least one parameter based at least in part on the measurement.

### BACKGROUND

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones) and others are sensitive to particle motion (e.g., geophones). Industrial surveys may deploy only one type of sensors or both. In response to the detected seismic events, the sensors generate electrical signals to produce seismic data. Analysis of the seismic data can then indicate the presence or absence of probable locations of hydrocarbon deposits.

One type of seismic source is an impulsive energy source, such as dynamite for land surveys or a marine air gun for marine surveys. The impulsive energy source produces a relatively large amount of energy that is injected into the earth in a relatively short period of time. Accordingly, the resulting data generally has a relatively high signal-to-noise ratio, which facilitates subsequent data processing operations. The use of an impulsive energy source for land surveys may pose certain safety and environmental concerns.

Another type of seismic source is a seismic vibrator, which is used in connection with a “vibroseis” survey. For a seismic survey that is conducted on dry land, the seismic vibrator imparts a seismic source signal into the earth, which has a relatively lower energy level than the signal that is generated by an impulsive energy source. However, the energy that is produced by the seismic vibrator's signal lasts for a relatively longer period of time.

### SUMMARY

The summary is provided to introduce a selection of concepts that are further described below in the detailed description. This summary is not intended to identify key or essential features of the claimed subject matter, nor is it intended to be used as an aid in limiting the scope of the claimed subject matter.

In an exemplary implementation, a technique includes determining at least one parameter to regulate actuation of a seismic source based on a frequency-based maximum deliverable output for the source. The technique includes using at least one sensor to acquire a measurement of an output of the source in response to the source being regulated using the parameter(s) and processing data representative of the measurement in a processor-based machine to selectively update the frequency-based maximum deliverable output and the parameter(s) based at least in part on the measurement.

In another exemplary implementation, a system including an interface and a processor. The interface receives first data representative of a frequency-based maximum deliverable output for a seismic source when actuated and second data representative of at least one measurement of an output of the seismic source acquired by at least one sensor. The processor selectively updates the frequency-based maximum output and re-determines the parameter(s) based at least in part on the measurement.

In yet another exemplary implementation, an article including a non-transitory computer readable storage medium to store instructions that when executed by a processor-based machine cause the processor-based machine to determine at least one parameter to regulate actuation of a seismic source based on a frequency-based maximum deliverable output for the energy source when actuated. The article includes selectively updating the frequency-based maximum deliverable output and the parameter(s) based at least in part on the measurement.

Advantages and other features will become apparent from the following drawing, description and claims.

### BRIEF DESCRIPTION OF THE DRAWINGS

FIG. 1 is a schematic diagram of a vibroseis acquisition system according to an example implementation.

FIGS. 2 and 3 are flow diagrams depicting techniques to calibrate a seismic vibrator according to example implementations.

FIG. 4 is a schematic diagram of a marine-based towed seismic data acquisition system according to an example implementation.

FIG. 5 is a flow diagram depicting a technique to calibrate a source of the acquisition system of FIG. 4 according to an example implementation.

FIG. 6 is a schematic diagram of a data processing system according to an example implementation.

FIG. 7 is a workflow illustrating determination of a performance profile for a vibrator according to an example implementation.

### DETAILED DESCRIPTION

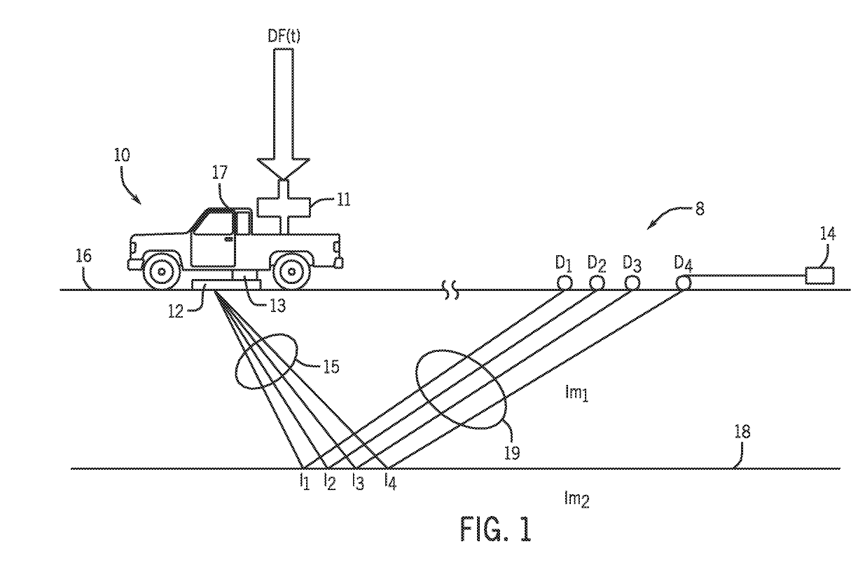

Referring to FIG. 1, a land-based vibroseis acquisition system 8 in accordance with example implementations includes an Earth surface-disposed seismic vibrator 10; surface-located geophones D₁, D₂, D₃ and D₄; and a data acquisition system 14. To perform a vibroseis survey, the seismic vibrator 10 generates a seismic source signal 15 for purposes of injecting a vibroseis sweep into the earth. An interface 18 between subsurface impedances Im₁ and Im₂ reflects the signal 15 at points I₁, I₂, I₃ and I₄ to produce a reflected signal 19 that is detected by the geophones D₁, D₂, D₃ and D₄; respectively. The data acquisition system 14 gathers the raw seismic data acquired by the geophones D₁, D₂, D₃ and D₄, and the raw seismic data may be processed to yield information about subsurface reflectors and the physical properties of subsurface formations.

For purposes of generating the seismic source signal 15, the seismic vibrator 10 contains an hydraulic actuator that drives a vibrating element 11 in response to a driving signal (called “DF(t)”). More specifically, the driving signal DF(t) may be a sinusoid whose amplitude and frequency are changed during the sweep, as further discussed below. Because the vibrating element 11 is coupled to a base plate 12 that is in contact with the earth surface 16, the energy from the element 11 is coupled to the earth to produce the seismic source signal 15.

It is noted that in accordance with other example implementations, the vibrating element 11 may be driven by an actuator other than a hydraulic actuator. For example, in accordance with other example implementations, the vibrating element 11 may be driven by an electro-magnetic actuator. Additionally, in accordance with other implementations, the seismic vibrator 10 may be located offshore or in a borehole and thus, may not be located at the surface. In accordance with further example implementations, seismic sensors, such as geophones, may alternatively be located in a borehole. Therefore, although specific examples of surface-located seismic vibrators and seismic sensors are set forth herein, it is understood that the seismic sensors, the seismic vibrator or both of these entities may be located downhole depending on the particular implementations, as many variations are contemplated and are within the scope of the appended claims.

Among its other features, the seismic vibrator 10 may include a signal measuring apparatus 13, which includes sensors (accelerometers, for example) to measure the seismic source signal 15 (i.e., to measure the output force of the seismic vibrator 10). As depicted in FIG. 1, the seismic vibrator 10 may be mounted on a truck 17 in an arrangement that enhances the vibrator's mobility.

The vibrating element 11 contains a reaction mass that oscillates at a frequency and amplitude that is controlled by the driving signal DF(t): the frequency of the driving signal DF(t) sets the frequency of oscillation of the reaction mass; and the amplitude of the oscillation, in general, is controlled by a magnitude of the driving signal DF(t). During the sweep, the frequency of the driving signal DF(t) transitions (and thus, the oscillation frequency of the reaction mass transitions) over a range of frequencies, one frequency at time. The amplitude of the driving signal DF(t) is also varied during the sweep pursuant to a designed amplitude-time envelope, as further described below. The maximum force profile may be a function of the physical constraints that are imposed by the seismic vibrator, as well as constraints that are imposed by geophysical properties of the earth.

Better survey results typically are obtained by maximizing the energy that the seismic vibrator 10 injects into the earth, which means that optimal results typically are obtained, in general, by maximizing the force that is generated by the oscillating reaction mass. In general, a larger amplitude of oscillation for the reaction mass is required at the lower end of the frequency range to deliver the same force as the force delivered for a smaller amplitude of oscillation at the higher end of the frequency range. However, the seismic vibrator 10 has physical limitations, which control the maximum displacement of the reaction mass. The limitations on the maximum displacement vary with frequency. Because the displacement of the reaction mass is a function of the driving signal DF(t), the above-described physical limitations of the seismic vibrator 10 establish a frequency-based maximum deliverable output (herein also called a “performance profile”) for the vibrator 10.

More specifically, for a given oscillation frequency, the seismic vibrator 10 has an associated maximum deliverable output: a maximum output force of the vibrator 10 while maintaining a harmonic content of the vibrator's output at or below an acceptable level. Thus, driving the seismic vibrator at an output force above this maximum level produces no increase in the output force, produces an output force that has an unacceptable level of harmonic distortion, and/or produces an output force that is otherwise less than optimum. The limiting driving forces for the different frequencies collectively form the frequency-based maximum deliverable output profile, or performance profile, which, as described further below, may be used to design a vibroseis sweep.

One way to determine the performance profile for the seismic vibrator 10 is to empirically determine the profile by driving the vibrator 10 at different driving forces at each frequency of a range of discrete frequencies. Such a technique is described in, for example, U.S. Pat. No. 7,974,154, entitled, “VIBROSEIS CALIBRATION TECHNIQUE AND SYSTEM,” which granted on Jul. 5, 2011 and is hereby incorporated by reference in its entirety. Techniques and systems are disclosed herein for purposes of simultaneously determining the sweep (for a specific vibrator and terrain combination) and the frequency-based maximum deliverable output (i.e., the performance profile) in relatively fewer iterations, in accordance with example implementations (i.e., to determine parameters to effectively calibrate the seismic source).

More specifically, in accordance with example implementations, the technique that is disclosed in U.S. Pat. No. 7,974,154 may be used to derive performance profiles (called “Dⱼ(fᵢ)”) for a given vibrator (or vibrator model) for different parts of the world on different terrains. Thus, the determination of the performance profile for a given vibrator at a given location may begin with selecting one of the Dⱼ(fᵢ) performance profiles, and then, as disclosed herein, a number of iterations may be performed for purposes of ultimately determining a performance profile for the specific terrain and the specific seismic vibrator 10. This derived performance profile is referred to as the “D_{M}(fᵢ)” performance profile herein and is derived in one or more iterations, where each iteration involves estimating a performance profile; determining a sweep based on this estimate; acquiring measurement of an output of a source activated according to the determined sweep; and assessing the estimated performance profile based on this measurement. During the iterations disclosed herein, each iteration is used to derive a performance profile denoted as “Dₖ(fᵢ)” herein, where “k” represents the index number. After a relatively few k (wherein “k” may be as small as “1”), iterations, the Dₖ(fᵢ) performance profile derived in the last iteration is the one used to design the sweep that ideally optimizes uses the source performance profile.

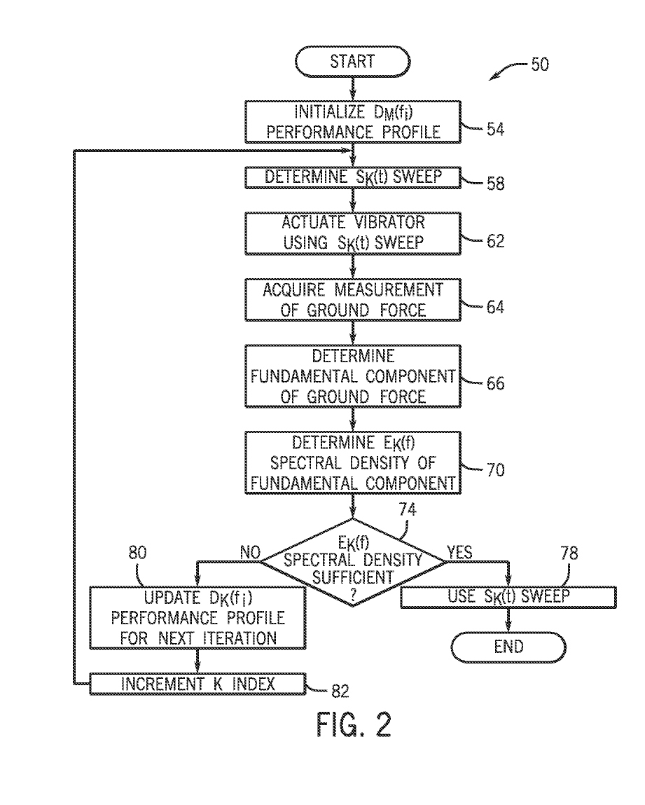

More specifically, FIG. 2 depicts a technique 50 for deriving the Dₘ(fᵢ) performance profile in accordance with example implementations. First, pursuant to the technique 50, the determination of the Dₘ(fᵢ) performance profile is initialized, pursuant to block 54, by selecting an initial performance profile based on the terrain and vibrator/vibrator model (using an available set of Dⱼ(fᵢ) profiles and/or by using a model, for example); and correspondingly initializing the Dₖ(fᵢ) performance profile to this value.

Pursuant to block 58 of the technique 50, based on the Dₖ(fᵢ) performance profile, a sweep (called “Sₖ(t)” herein) is determined. As an example, the Sₖ(t) sweep may be determined as follows, assuming that the performance profile in the frequency domain is represented by “DF(f),” and the desired, or expected, energy spectral density to be injected into the ground is represented by “E_{T}(f).” The sweep rate (called “SR(f)”) in the frequency domain may be determined according to the following equation:

$$SR ( f ) = 4 \frac{{E}_{T} ( f )}{{DF}^{2} ( f )} . \qquad Eq . 1$$

From Eq. 1, the times at which the instantaneous frequencies (called “fᵢ”) are injected into the ground may be determined, as described below:

tᵢ(fᵢ)=∫_{f}_{ₘᵢₙ}^{f}^{ₜ}SR(f)df, Eq. 2

where “fₘᵢₙ” represents the sweep minimum frequency of interest, and “tᵢ(fᵢ)” represents a monotonic function of fᵢ that may be numerically inverted to obtain the time dependent instantaneous frequency that is injected into the ground, or “\hat{f}ᵢ(t).”The sweep Sₖ(t) for the DF(t) performance profile in the time domain is determined, as described below:

Sₖ(t)=DF(\hat{f}ᵢ(t))sin(1π∫₀\hat{f}ᵢ(t)dt+α), Eq. 3

wherein “α” represents a user-defined initial phase.

More details regarding the use of a performance profile to determine a vibroseis sweep may be found in U.S. Pat. No. 7,327,633, entitled, “SYSTEMS AND METHODS FOR ENHANCING LOW-FREQUENCY CONTENT IN VIBROSEIS ACQUISITION,” which issued on Feb. 5, 2008, and is hereby incorporated by reference in its entirety.

Thus, in the initial, or first, iteration of the technique 50, the D₁(fᵢ) performance profile is used to determine the S₁(t) sweep (i.e., the Sₖ(t) sweep for k=1), pursuant to block 62. The vibrator may then be actuated using the S₁(t) sweep so that a measurement of the resulting ground force may be acquired, pursuant to block 62. Based on the measured ground force (block 64), the fundamental component of the ground force is determined, pursuant to block 66. This fundamental component, in turn, may be used to assess and potentially further refine the Dₖ(fᵢ) performance profile, as described below.

More specifically, in accordance with example implementations, the technique 50 includes determining (block 70) the measured energy spectral density (called “Eₖ(t)” herein) of the determined fundamental component and comparing (decision block 74) the Eₖ(t) spectral density to the E_{T}(f) expected spectral density to determine whether the Eₖ(t) spectral density is sufficient. As an example, in accordance with some implementations, the Eₖ(t) measured and E_{T}(f) expected spectral densities are compared on a frequency-by-frequency basis. For example, in accordance with some implementations, decision block 74 may involve determining whether |Eₖ(f)−E_{T}(f)|≦ε (where “ε” is a user-defined value) holds true for a range of discrete frequencies (“f”).

Thus, at each frequency generated by the Sₖ(t) sweep, the difference between the E_{T}(f) expected spectral density and the Eₖ(t) measured spectral density may be determined, and if this difference is more than the ε user-defined value, then a new iteration is performed to further refine the Dₖ(fᵢ) performance profile.

More specifically, as depicted in FIG. 2, in accordance with some implementations, the technique 50 includes using the Sₖ(t) sweep, pursuant to block 78 (i.e., Dₖ(fᵢ) is the determined Dₘ(fᵢ) performance profile), if the difference between the Eₖ(t) measured and E_{T}(f) expected spectral densities are within the user defined value ε, or otherwise updating (block 80) the Dₖ(fᵢ) performance profile accordingly. If a decision is made, pursuant to decision block 74, to update the Dₖ(fᵢ) performance profile , then the profile (Dₖ₊₁(f)) for the next iteration (k+1) may be determined as follows:

$${D}_{k + 1} ( f ) = min ( {D}_{k} ( f ) , ( 1 - α ( F ) ) {D}_{k} ( f ) + α ( f ) \frac{4 {E}_{k} ( f )}{{ξ}_{k} ( f )} ) , \qquad Eq . 4$$

where “α(f)” is a weighting function that is between zero and one; and “ξₖ(f)” is the sweep rate determined at iteration k. Thus, in conjunction with block 82, the k index is incremented and control returns to block 58 for another iteration.

There are situations in which the generated fundamental component of the ground force obtained with the sweep Sₖ(t) at iteration k produces an Eₖ(f) measured spectral energy that exceeds E_{T}(f) expected spectral energy. This “overshooting” means that the control electronics of the vibrator 10 has not been able to control the vibrator 10 at those frequencies and time interval. One approach to handle this situation is to not increase the Dₖ₊₁(fᵢ) force in the next iteration at those frequencies where overshooting occurred. This is the reason for the Dₖ₊₁(fᵢ) constraint in Eq. 4 for updating the performance profile, i.e. is: Dₖ₊₁(f)<Dₖ(f). The performance profile is updated by weighting the drive force to design the sweep for the current iteration step and the drive that should be used to obtain the Ek(f) measured spectral density. The weight function α(f), which may be frequency dependent, is between zero and one. According to Eq. 4, when α(f) is equal to 1, the new performance profile is entirely obtained using the energy spectral density of the fundamental component of the ground force Eₖ(f), which is experimentally measured.

The above iterative procedure assumes that instantaneous frequency and Fourier variable f set are identical. The instantaneous frequency coincides with the variable f of the Fourier transform used to determine the energy spectral density when the quasi-stationary condition is satisfied. The quasi-stationary condition is satisfied when there are no rapid variations of the phase of the integrand function of the Fourier integral. A sufficient condition for the validity of the quasi-stationary condition is that neither the E_{T}(f) expected energy spectral density nor the Dⱼ(fᵢ) performance profile contain rapid variations. The Dⱼ(fᵢ) performance profile is typically a sufficiently slowly varying function of fᵢ so that the validity of the quasi-stationary condition is dictated by E_{T}(f). Variations of the E_{T}(f) expected spectral density that do not exceed 12 decibels (dB) per octave are sufficiently slow for the application of the method in seismic exploration, in accordance with example implementations. The quasi-stationary condition can however be verified taking into account that for a generic sweep as set forth below:

s(t)=A(t)cos(2πφ(t)+β), and Eq. 5

its energy spectral density may be approximated in a quasi-stationary condition with

E(f)=|S(f)|²=0.25A²(τ)/φ″(τ), Eq. 6

where “τ” represents the stationary point, i.e. the solution of the equation φ′(τ−f=0.

Other variations are contemplated and are within the scope of the appended claims. For example, in accordance with further implementations, the envelope (herein called “ [symbol] ”) of the fundamental force may be used for purposes of updating the Dₖ(fᵢ) performance profile as follows:

Dₖ₊₁(f)=min(Dₖ(f),(1−α(f))Dₖ(f)+α(f) [symbol] ). Eq. 7

The [symbol] fundamental force envelope may be derived from determining the absolute value of the Hilbert transform of the fundamental force, in accordance with example implementations. A particular advantage of this technique is that the [symbol] fundamental force envelope is a relatively local estimation. A relative advantage of the technique 50, as compared to using the fundamental force envelope, is that the fundamental force envelope may be relatively more sensitive to noise.

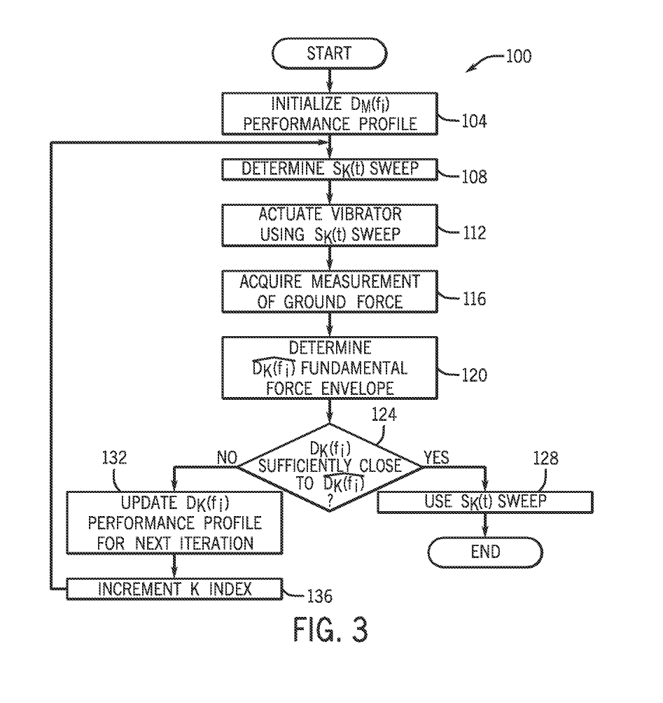

Referring to FIG. 3, in accordance with an example implementation, a technique 100 may be used for purposes of determining the Dₖ(fᵢ) performance profile in relatively few iterations (one or more iterations, for example) based on the [symbol] fundamental force envelope. Pursuant to the technique 100, the initial value for the Dₖ(fᵢ) performance profile may be selected for a particular vibrator/vibrator model) from a set of modeled Dₖ(fᵢ) performance profiles for different terrains. Alternatively, the Dₖ(fᵢ) performance profile may be initially derived using a model. Next, pursuant to the technique 100, the Sₖ(t) sweep is determined, pursuant to block 108, and the vibrator is actuated (block 112) to acquire a corresponding ground force measurement. The ground force is measured (block 114) of the measured ground force component is then determined, pursuant to block 116, and from the measured ground force, the [symbol] fundamental force envelope as the function of instantaneous frequency may be determined, pursuant to block 120.

A determination is then made (decision block 124), pursuant to the technique 100, to determine whether the Dₖ(fᵢ) performance profile is sufficiently close to the [symbol] fundamental force envelope. In other words, in accordance with example implementations, the following determination may be made: |Dₖ(fᵢ)− [symbol] |≦ε for each fᵢ frequency. If so, then the current Sₖ(t) sweep derived in the current iteration is used, pursuant to block 128, as the performance profile has been determined. Otherwise, the Dₖ(fᵢ) performance profile is selectively updated based on the current Dₖ(fᵢ) performance profile and the [symbol] maximum driving force envelope; and the k index is correspondingly incremented, pursuant to block 136, before control returns to block 108.

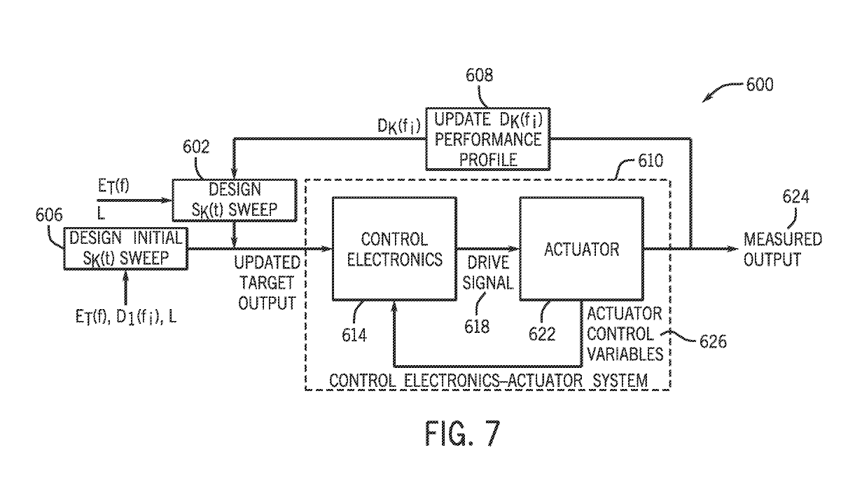

Thus, referring to FIG. 7, in accordance with an example implementation, a workflow 600 may be used for purposes of designing a performance profile for a seismic vibrator. Pursuant to the workflow 600, an initial Sₖ(t) sweep is designed (block 606) based on the expected spectral density and sweep length. This initial performance profile is then provided to a control electronics-actuator system 610 of the seismic vibrator. In this regard, in response to the performance parameter, control electronics 614 of the system 610 generates a drive signal 618, which actuates an actuator 622 of the vibrator to produce a vibrator output, thereby resulting in a measured output 624. The measured output 624, in turn, is used to update (block 608) the Dₖ(f) performance profile, which is provided for purposes of designing (block 602) the Sₖ(t) sweep. The feedback provided via blocks 602 and 608 may be used in one or more iterations to determine the sweep and performance profile, as disclosed herein.

In accordance with further example implementations, the techniques and systems that are disclosed herein may likewise be applied to determine a maximum output of a seismic source other than a vibrator. Moreover, the techniques and systems that are disclosed herein may be applied to an output other than a force. For example, in accordance with example implementations, techniques and systems that are disclosed herein may be applied for purposes of determining a maximum output pressure for a towed seismic source. As an example, the source may be an air gun or an array of air guns, depending on the particular implementation.

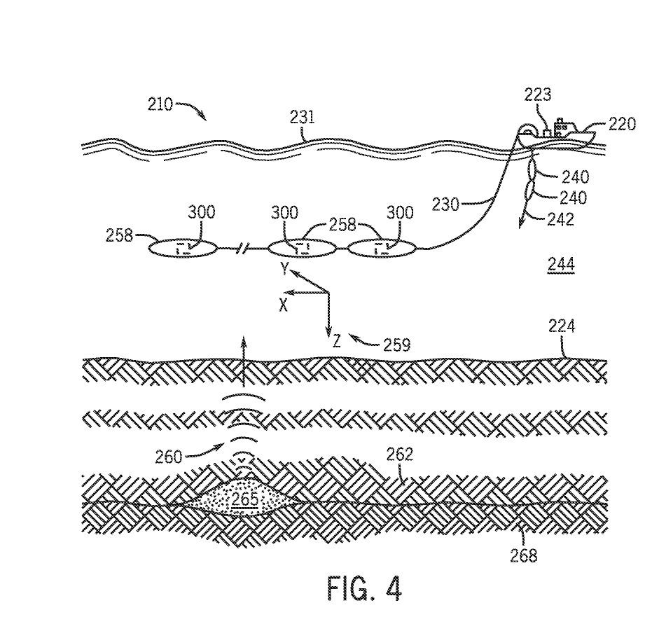

As a more specific example, FIG. 4 depicts a marine-based seismic data acquisition system 210, in accordance with an example implementation. In the system 210, a survey vessel 220 tows one or more seismic streamers 230 (one exemplary streamer 230 being depicted in FIG. 4) behind the vessel 220. It is noted that the streamers 230 may be arranged in an array, or spread, in which multiple streamers 230 are towed in approximately the same plane at the same depth. As another example, the streamers may be towed at multiple depths, such as in an over/under spread, for example. Moreover, the streamers 230 of the spread may be towed in a coil acquisition configuration and/or at varying depths or slants, depending on the particular implementation.

The streamer 230 may be several thousand meters long and may contain various support cables (not shown), as well as wiring and/or circuitry (not shown) that may be used to support communication along the streamer 230. In general, the streamer 230 includes a primary cable into which is mounted seismic sensors that record seismic signals. In accordance with example implementations, the streamer 230 contains seismic sensor units 258, each of which contains one or multiple multi-component sensors 300. The multi-component sensor 300 includes a hydrophone and particle motion sensors, in accordance with some embodiments of the invention. Thus, each multi-component sensor 300 is capable of detecting a pressure wavefield and at least one component of a particle motion that is associated with acoustic signals that are proximate to the sensor. Examples of particle motions include one or more components of a particle displacement, one or more components (inline (x), crossline (y) and vertical (z) components (see axes 259, for example)) of a particle velocity and one or more components of a particle acceleration.

Depending on the particular implementation, the multi-component sensor 100 may include one or more hydrophones, geophones, particle displacement sensors, particle velocity sensors, accelerometers, pressure gradient sensors, or combinations thereof.

As a more specific example, in accordance with some implementations, a particular multi-component sensor 300 may include a hydrophone for measuring pressure and three orthogonally-aligned accelerometers to measure three corresponding orthogonal components of particle velocity and/or acceleration near the sensor. It is noted that the multi-component sensor 300 may be implemented as a single device (as depicted in FIG. 4) or may be implemented as a plurality of devices, depending on the particular embodiment of the invention. A particular multi-component sensor 300 may also include pressure gradient sensors, which constitute another type of particle motion sensors. Each pressure gradient sensor measures the change in the pressure wavefield at a particular point with respect to a particular direction.

In addition to the streamer(s) 230 and the survey vessel 220, the marine seismic data acquisition system 210 includes at least one seismic source element 240, such as the two exemplary seismic source elements 240 that are depicted in FIG. 4, such as air guns and the like. In some implementations, the seismic source elements 240 may be coupled to, or towed by, the survey vessel 220. Alternatively, in other implementations, the seismic source elements 240 may operate independently of the survey vessel 220, in that the source elements 240 may be coupled to other vessels or buoys, as just a few examples.

As the seismic streamers 230 are towed behind the survey vessel 220, the seismic source elements 240 are activated, or fired, to produce acoustic signals 242 (an exemplary acoustic signal 242 being depicted in FIG. 4), often referred to as “shots,” which propagate down through a water column 244 into strata 262 and 268 beneath a water bottom surface 224. The acoustic signals 242 are reflected from the various subterranean geologic formations, such as an exemplary formation 265 that is depicted in FIG. 4.

The incident acoustic signals 242 that are created by the seismic sources 240 produce corresponding reflected acoustic signals, or pressure waves 260, which are sensed by the seismic sensors of the streamer(s) 230. It is noted that the pressure waves that are received and sensed by the seismic sensors include “upgoing” pressure waves that propagate to the sensors without reflection, as well as “downgoing” pressure waves that are produced by reflections of the pressure waves 260 from the air-water boundary, or free surface 231.

The multicomponent sensors 300 generate “traces,” or signals (digital signals, for example), which form the acquired, spatially and temporally sampled measurements of the pressure wavefield and particle motion. The traces are recorded as seismic data and may be at least partially processed by a signal processing unit 223 that is deployed on the survey vessel 220, in accordance with some implementations. For example, a particular multi-component sensor 300 may provide a trace, which corresponds to a measure of a pressure wavefield by its hydrophone; and the sensor 300 may provide (depending on the particular implementation) one or more traces that correspond to one or more components of particle motion.

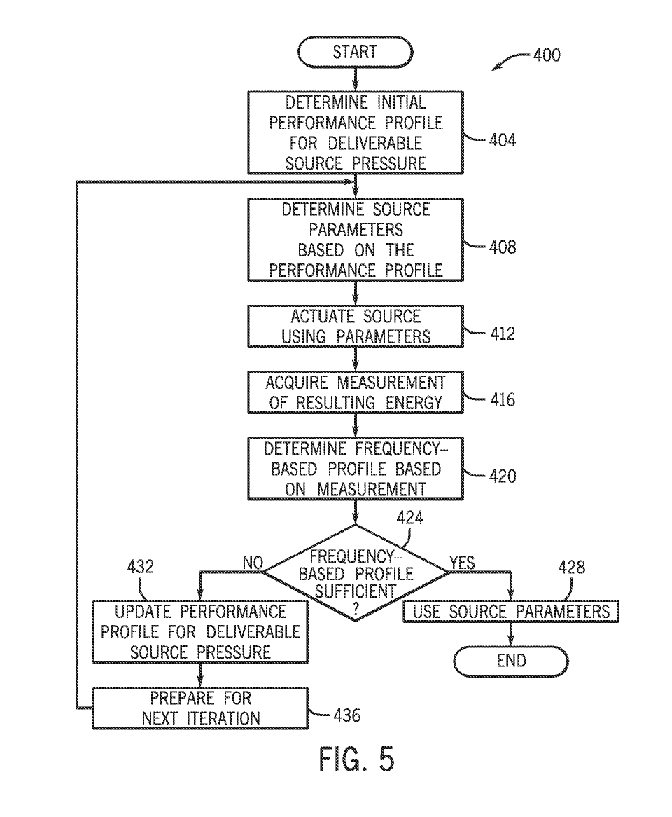

The maximum deliverable source pressure of a towed seismic source (i.e., a source formed from one or more air guns, for example) may depend on a number of different factors. For example, the deliverable force may depend on the geometry or spatial arrangement of the sources of a source array, the volumes of the source elements (i.e., the volumes of the air guns, for example), the durations in which the individual source elements are actuated, malfunctioning source elements or underperforming source elements, configuration characteristics that vary among the source elements, and so forth. A technique 400 that is depicted in FIG. 5 may be used, in accordance with example implementations, for purposes of performing relatively few iterations to determine a maximum deliverable source pressure for such a seismic source.

More specifically, pursuant to the technique 400, an initial frequency-based maximum deliverable source pressure, or performance profile, is selected, pursuant to block 404. The performance profile may be selected from maximum deliverable frequency-based source profiles determined from similar surveys, similar towed source elements, similar source configurations, and so forth. Moreover, in accordance with some implementations, the performance profile may be determined from a model or a combination of modeled and experimental results.

Regardless of the derivation of the initial performance profile, the technique 400 includes determining (block 408) corresponding source parameters based on the profile. Thus, this determination may involve determining the specific array configuration, identifying source elements to be replaced, determining a volume for the source array or source elements of the array, and so forth. Next, pursuant to the technique 400, the source is actuated (block 412) using the parameters and a corresponding measurement of the source output is acquired, pursuant to block 416.

The acquired measurement may then be processed, pursuant to block 420, for purposes of determining a frequency-based maximum output, or performance profile, based on the measurement. In this manner, a spectral density of the measurement or frequency signature may be examined, depending on the particular implementation. If a determination is made (decision block 424) that the frequency-based profile is sufficiently close to an expected frequency-based profile, then the source parameters determined in the latest iteration may be thereafter used and a corresponding seismic survey may be then conducted, pursuant to block 428. Otherwise, if, pursuant to decision block 424, a determination is made that the measured frequency-based profile is not sufficiently close to the expected frequency-based profile, then the source parameters are updated (block 432) based on the current performance profile and the expected frequency-based profile and preparations are then made (block 436) for the next iteration before control returns to block 408.

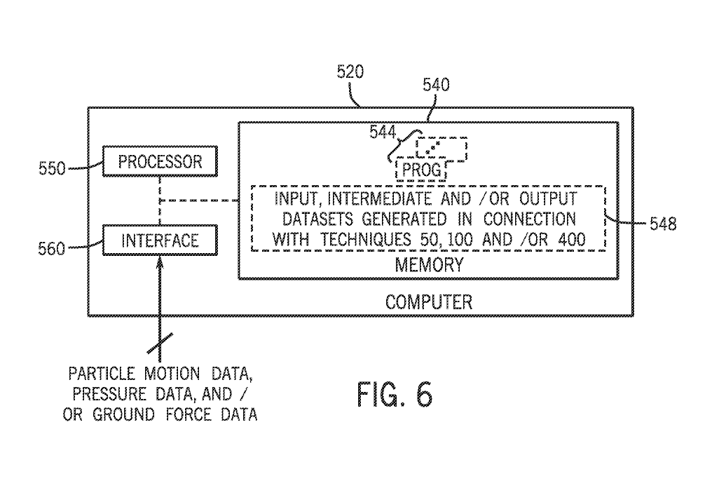

Referring to FIG. 6, in accordance with some implementations, a machine, such as a data processing system 520, may contain a processor 550 for purposes of processing acquired data to calibrate a seismic source, as disclosed herein.

In accordance with some implementations, the processor 550 may be formed from one or more microprocessors and/or microprocessor processing cores and thus, may be itself be formed from multiple processors. In general, the processor 550 is a general purpose processor, and may be formed from, depending on the particular implementation, one or multiple Central Processing Units (CPUs), or application specific integrated circuits (ASICs), field programmable gate arrays (FPGAs), programmable logic devices (PLDs), or other appropriate devices, as can be appreciated by the skilled artisan. As a non-limiting example, the processor 550 may be part of the circuitry 223 on the vessel 220, or may be disposed at a remote site. Moreover, the data processing system 520 may be a distributed processing system, in accordance with further implementations.

As depicted in FIG. 6, the processor 550 may be coupled to a communication interface 560 for purposes of receiving such data indicative of acquired measurements acquired by sensors in a land-based or marine-based survey. As examples, the communication interface 560 may be a Universal Serial Bus (USB) interface, a network interface, a removable media interface (a flash card, CD-ROM interface, etc.) or a magnetic storage interface (an Intelligent Device Electronics (IDE)-compliant interface or Small Computer System Interface (SCSI)-compliant interface, as non-limiting examples). Thus, the communication interface 560 may take on numerous forms, depending on the particular implementation.

In accordance with some implementations, the processor 550 is coupled to a memory 540 that stores program instructions 544, which when executed by the processor 550, may cause the processor 550 to perform various tasks of one or more of the techniques and systems that are disclosed herein, such as the technique 50, 100 and/or 400. As a non-limiting example, in accordance with some implementations, the instructions 544, when executed by the processor 550, may cause the processor 550 to determine at least one parameter to regulate actuation of a seismic source based on a frequency-based maximum deliverable output for the source when actuated; selectively update the frequency-based maximum deliverable output for the source and re-determine the at least one parameter based at least in part on a measurement of the seismic source.

In general, the memory 540 is a non-transitory storage memory and may be formed from (as non-limiting examples) semiconductor storage devices, magnetic storage devices, optical storage devices, phase change memory storage devices, capacitor-based storage devices, and so forth, depending on the particular implementation. Moreover, the memory 540 may be formed from more than one of these non-transitory memory storage devices, in accordance with further implementations. When executing one or more of the program instruction 544, the processor 550 may store preliminary, intermediate and/or final datasets 548 obtained via the execution of the program instructions 544.

It is noted that the data processing system 520 of FIG. 6 is merely an example of one out of many possible architectures for such a system, in accordance with the techniques and systems that are disclosed herein. Moreover, the data processing system 520 is represented in a simplified form, as the processing system 520 may have various other components (a display to display initial, intermediate and/or final results of the system's processing, input/output devices, and so forth, as non-limiting examples), as can be appreciated by the skilled artisan.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
determining at least one parameter to regulate actuation of a seismic source based on a frequency-based maximum deliverable output for the source;
using at least one sensor to acquire a measurement of an output of the source in response to the source being regulated using the at least one parameter; and
processing data representative of the measurement in a processor-based machine to selectively update the frequency-based maximum deliverable output and the at least one parameter based at least in part on the measurement.

2. The method of claim 1, wherein:
the source comprises a vibroseis source;
determining the at least one parameter comprises determining a sweep; and
the frequency-based maximum deliverable output comprises a maximum delivered force for the vibroseis source.

3. The method of claim 2, further comprising:
extracting a fundamental component from the measurement; and
selectively updating the frequency-based maximum deliverable output and the at least one parameter based at least in part on the extracted fundamental component.

4. The method of claim 2, further comprising:
extracting a fundamental component from the measurement;
determining a fundamental force envelope based on the extracted fundamental component; and
selectively updating the frequency-based maximum deliverable output and the at least one parameter based at least in part on the determined fundamental force envelope.

5. The method of claim 2, further comprising initializing the frequency-based maximum deliverable output, the initializing comprising selecting one of a plurality of frequency-based maximum deliverable output profiles associated with a plurality of terrains.

6. The method of claim 2, wherein selectively updating the frequency-based maximum deliverable output comprises constraining the output t to not exceed the frequency-based maximum deliverable output before the update.

7. The method of claim 1, wherein:
the source comprises a towed marine source; and
the frequency-based maximum deliverable output comprises a maximum pressure profile for the towed marine source.

8. The method of claim 7, wherein the at least one parameter comprises at least one of the following: a number of source elements forming the marine source, an air volume of the marine source and a spatial configuration of source elements of the marine source.

9. A system comprising:
an interface to receive first data representative of a frequency-based maximum deliverable output for a seismic source when actuated and second data representative of at least one measurement of an output of the seismic source acquired by the at least one sensor; and
a processor to
selectively update the frequency-based maximum output and redetermine the at least one parameter based at least in part on the measurement.

10. The system of claim 9, wherein the seismic source comprises a vibroseis source and the frequency-based maximum deliverable output comprises a delivered force for the vibroseis source.

11. The system of claim 10, wherein the processor is adapted to:
extract a fundamental component from the measurement; and
selectively update the frequency-based maximum deliverable output and the at least one parameter based at least in part on the extracted fundamental component.

12. The system of claim 10, wherein the processor is adapted to:
extract a fundamental component from the measurement;
determine a fundamental force envelope based on the extracted fundamental component; and
selectively update the frequency-based maximum deliverable output and the at least one parameter based at least in part on the determined fundamental force envelope.

13. The system of claim 10, wherein the processor is adapted to initialize the frequency-based maximum deliverable output, the initialization comprising selecting one of a plurality of frequency-based maximum deliverable outputs associated with a plurality of terrains.

14. The system of claim 10, wherein the processor is adapted to constrain the updated frequency-based maximum deliverable output to not exceed the unupdated frequency-based maximum deliverable output.

15. The system of claim 9, wherein:
the seismic source comprises a towed marine source; and
the frequency-based maximum deliverable output comprises a maximum pressure profile for the towed marine source.

16. The system of claim 15, wherein the at least one parameter comprises at least one of the following: a number of source elements forming the marine source, an air volume of the marine source and a spatial configuration of source elements of the marine source.

17. An article comprising a non-transitory computer readable storage medium to store instructions that when executed by a processor-based machine cause the processor-based machine to:
determine at least one parameter to regulate actuation of a seismic source based on a frequency-based maximum deliverable output for the energy source when actuated; and
selectively update the frequency-based maximum deliverable output and the at least one parameter based on the measurement.

18. The article of claim 17, wherein the seismic source comprises a vibroseis source, the storage medium storing instructions that when executed by the processor-based system cause the processor-based system to:
determine a sweep for the vibroseis source based at least in part on the frequency-based maximum deliverable output.

19. The article of claim 17, wherein the maximum output comprises a maximum driving force profile, the storage medium storing instructions that when executed by the processor-based machine cause the processor-based machine to initialize selection of the frequency-based maximum deliverable output by selecting the frequency-based maximum deliverable output associated with a plurality of terrains.

20. The article of claim 17, wherein:
the seismic source comprises a towed marine source; and
the frequency-based maximum deliverable output comprises a maximum pressure profile for the towed marine source.
